(19) United States
(12) Patent Application Publication
(10) Pub. No.: US 2019/0224817 A1
(43) Pub. Date: Jul. 25, 2019

(54) PIPE PLIERS

(71) Applicant: PROXENE TOOLS CO., LTD., Taichung City (TW)

(72) Inventor: Arthur WU, Taichung City (TW)

(21) Appl. No.: 15/875,798

(22) Filed: Jan. 19, 2018

(51) Int. Cl. B25B 7/10; B25B 7/14; B25B 13/50

(52) U.S. Cl. CPC B25B 7/10; B25B 13/50; B25B 7/14

(57) ABSTRACT

The pipe pliers includes a first clamping body, a driving handle, and a clamping element. The first clamping body includes a body portion. The body portion includes two side plates and is formed with two guiding toothed grooves. A receiving groove is defined between the two side plates. Each side plate is formed with a sliding groove facing the other side plate. The driving handle is slidably arranged at the two guiding toothed grooves and is pivotable with respect to the first clamping body. The driving handle has a protrusion. The clamping element is slidably arranged at the two sliding grooves. The clamping element has a recess. The protrusion is rotatably inserted into the recess. When clamping a workpiece, the clamping element slides linearly.

### BACKGROUND OF THE INVENTION

### Field of the Invention

The present invention relates to a hand tool, especially to a pipe pliers.

### Description of the Prior Art

A conventional pipe pliers includes a first clamping body and a second clamping body pivotally connected. The first clamping body has a sliding groove to allow the second clamping body to slide with respect to the first clamping body. A distance between a fixed clamping portion of the first clamping body and a movable clamping portion of the second clamping body is changeable by sliding the second clamping body. The movable clamping portion can be moved toward the fixed clamping portion by pivoting the second clamping body to clamp a pipe connector, as shown in patent TWM511931. However, in the conventional pipe pliers, the movable clamping portion approaches the fixed clamping portion by pivoting (in an arc path). When clamping the connector, the line defined by the force points of the fixed clamping portion and the movable clamping portion doesn't penetrate the center of the clamped object. That is, the two clamping portions are not parallel. Thus, the connector may slide between or separate from the fixed clamping portion and the movable clamping portions.

The pipe pliers disclosed in the publication EP 0421107 includes a main body. The main body has a fixed jaw and a clamping element sldiably disposed on the main body. Each of two sides of the main body is formed with a sliding groove. The clamping element has two side plates. Each side plate has a protrusion on a face facing the other side plate. The two protrusions are slidably disposed in the two sliding grooves to make the clamping element slidably disposed on the main body. However, the two protrusions are difficult to be processed or shaped except precision casting. The clamping element manufactured by precision casting is not durable and costs too much.

The pliers disclosed in publication CN204843895 has a main body having two side plates. Each side plate is formed with a receiving groove. The clamping element (or the second pliers opening) having a guiding protrusion. The guiding protrusion is slidably disposed in the receiving groove to make the clamping element slidable with respect to the main body. However, the thickness of the guiding protrusion has to be larger than the width of the receiving groove for sliding. Thus, when assembling the clamping element and the main body, the two side plates (102 and 103 in this publication) have to be pulled away from each other, and the two protrusions enter the receiving groove followed by pushing the side plates until the clamping element is unable to leave the two side plates. The side plates are quite hard, so the operation has to be made by machines. However, the structure may be damaged to reduce the durability and accuracy. In addition, the length of the guiding protrusion along the sliding direction is short, so shaking is resulted between the clamping element and the main body. Besides, the guiding groove perpendicular to the receiving groove has plural teeth. During clamping, the guiding protrusion presses the teeth to damage the teeth.

### SUMMARY OF THE INVENTION

The main object of the present invention is to provide a pipe pliers having a first clamping portion and a second clamping portion sliding parallel to clamping the polygon pipe connector. In addition, the second clamping portion prevents from shaking so as to improve the accuracy.

To achieve the above and other objects, the pipe pliers of the present invention includes a first clamping body, a driving handle, and a clamping element. The first clamping body includes a first handle portion, a first clamping portion, and a body portion connected first handle portion and the first clamping portion therebetween. he body portion includes two side plates and is formed with two guiding toothed grooves. A receiving groove is defined between the two side plates. Each of the side plates is formed with a sliding groove on a face thereof facing the other side plate. The two sliding grooves are parallel to but not overlap the two guiding toothed grooves. The driving handle is restrictively and slidably arranged at the two guiding toothed grooves and pivotally connected to the first clamping body by a pivot portion. The driving handle has a second handle portion at an end and a protrusion at the other end. The clamping element includes a second clamping portion and a sliding piece connected to each other. The sliding piece is received in the receiving groove and slidably arranged in the two sliding grooves. The second clamping portion corresponds to the first clamping portion. The clamping element is formed with a recess. The protrusion is rotatably inserted in the recess. The protrusion is able to drive the clamping element to slide with respect to the first clamping body by the driving handle sliding or pivoting with respect to the first clamping body.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is a partial enlargement of the present invention;

FIG. 4 is a partial front view of the present invention;

FIG. 5 is a partial enlargement of the present invention;

FIG. 6 is an illustration of the present invention during operation;

FIG. 7 to FIG. 9 are front views of the present invention during operation;

FIG. 10 and FIG. 11 are A-A cross-sections of the present invention;

FIG. 10A and FIG. 11A are partial enlargements of FIG. 10 and FIG. 11;

FIG. 12 is a lateral view of the present invention;

FIG. 13 and FIG. 14 are B-B cross-sections of the present invention;

FIG. 13A and FIG. 14A are partial enlargements of FIG. 13 and FIG. 14;

FIG. 15 is a breakdown drawing showing a second embodiment of the present invention.

### DETAILED DESCRIPTION OF THE PREFERRED EMBODIMENTS

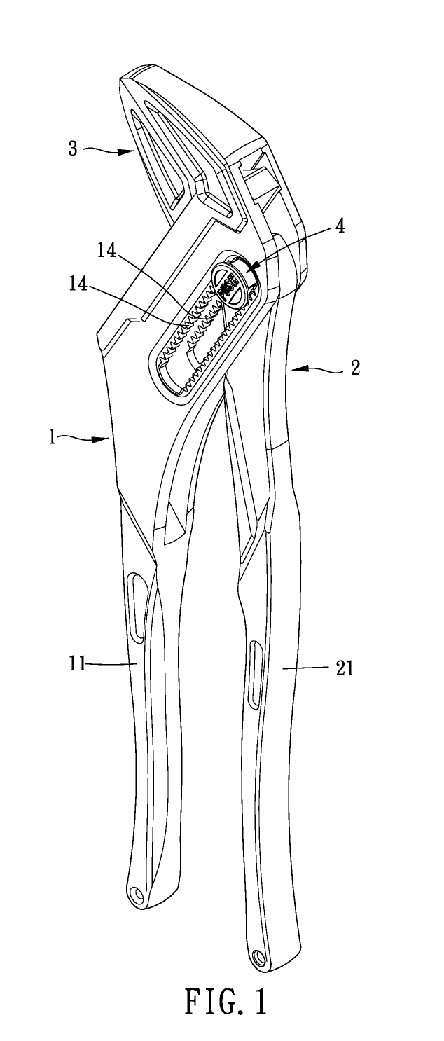

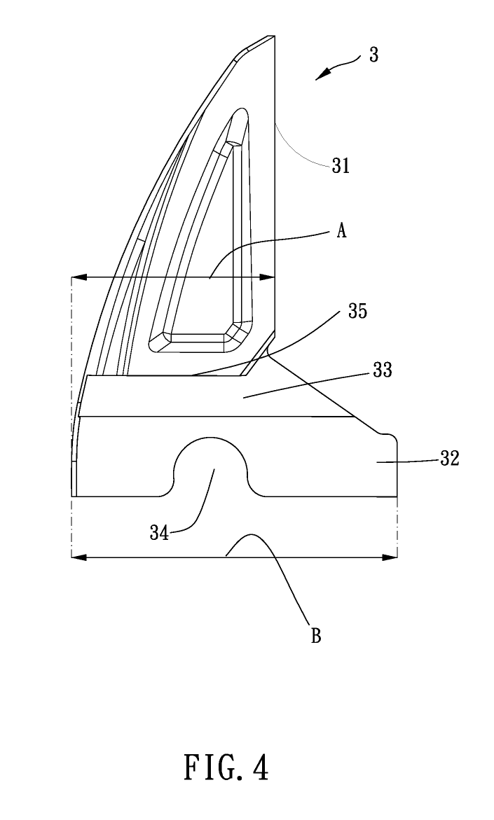

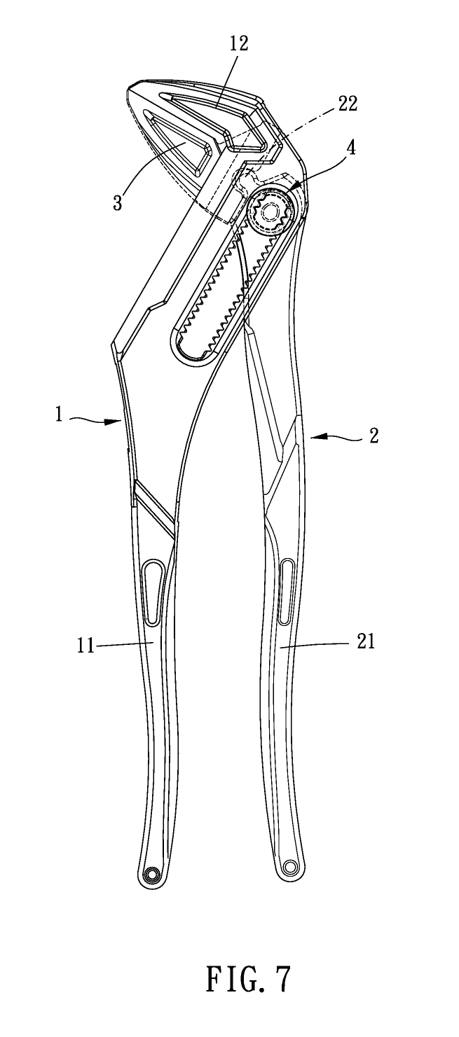

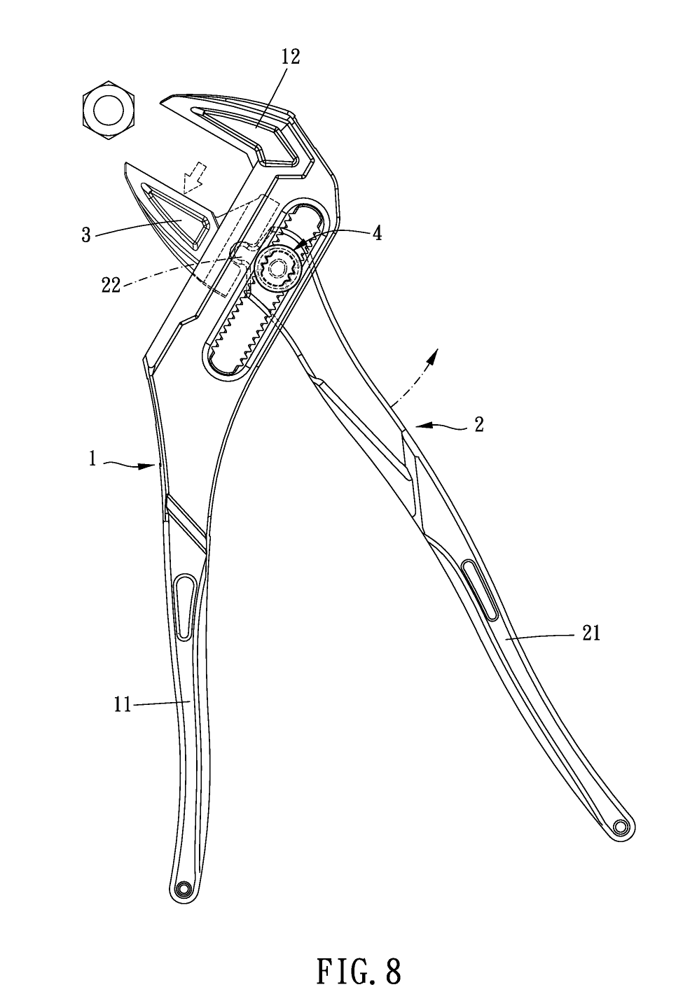

Please refer to FIG. 1 to FIG. 6, the pipe pliers of the present invention includes a first clamping body 1, a driving handle 2, and a clamping element 3.

The first clamping body 1 includes a first handle portion 11, a first clamping portion 12, and a body portion 13 connecting the first handle portion 11 and the first clamping portion 12 therebetween. The body portion 13 includes two side plates 131 and is formed with two guiding toothed grooves 14. A receiving groove 17 is defined between the two side plates 131. Each of the side plates 131 is formed with a sliding groove 15 on a face thereof facing the other side plate 131. The two sliding grooves 15 are parallel to but not overlap the two guiding toothed grooves 14.

The driving handle 2 is restrictively and slidably arranged at the two guiding toothed grooves 14 and is pivotally connected to the first clamping body 1 by a pivot portion 4. The driving handle 2 has a second handle portion 21 at an end and a protrusion 22 at the other end.

The clamping element 3 includes a second clamping portion 31 and a sliding piece 32. The sliding piece 32 is located in the receiving groove 17 and is slidably arranged in the two sliding grooves 15. The second clamping portion 31 corresponds to the first clamping portion 12. The clamping element 3 has a recess 34. The protrusion 22 is rotatably inserted into the recess 34.

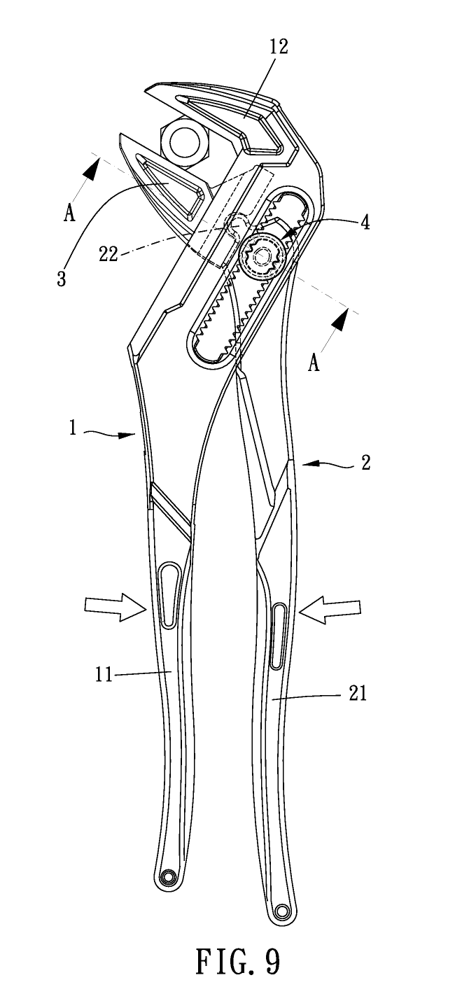

Please refer to FIG. 7 to FIG. 9, the protrusion 22 can drive the clamping element 3 to slide with respect to the first clamping body 1 due to the sliding or pivoting of the driving handle 2 with respect to the first clamping body 1. More specifically, when the driving handle 2 slides with respect to the first clamping body 1, as shown in FIG. 7 and FIG. 8, the driving handle 2 is free so that the protrusion 22 drives the clamping element 3 to slightly slide along the two sliding grooves 15 with respect to the first clamping body 1. When the driving handle 2 pivots with respect to the first clamping body 1, as shown in FIG. 9, the protrusion 22 is rotatable in the recess 34 so that the protrusion 22 can abut against the recess 34 to make it slightly slide along the two sliding grooves 15 with respect to the first clamping body 1. Thus, the second clamping portion 31 can approach or leave the first clamping portion 12 to clamp a polygonal pipe connector or other objects.

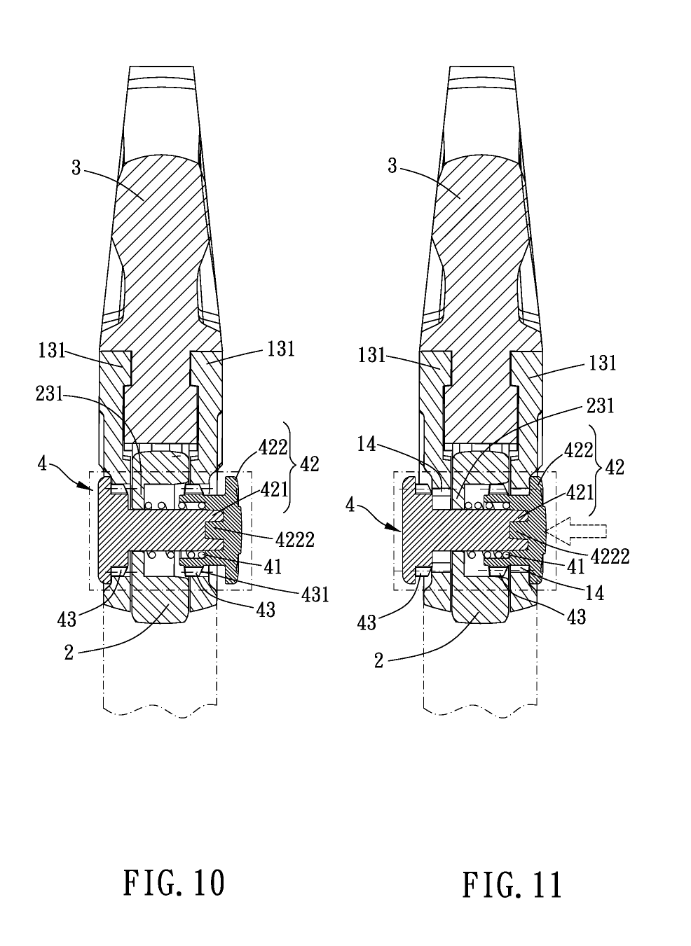

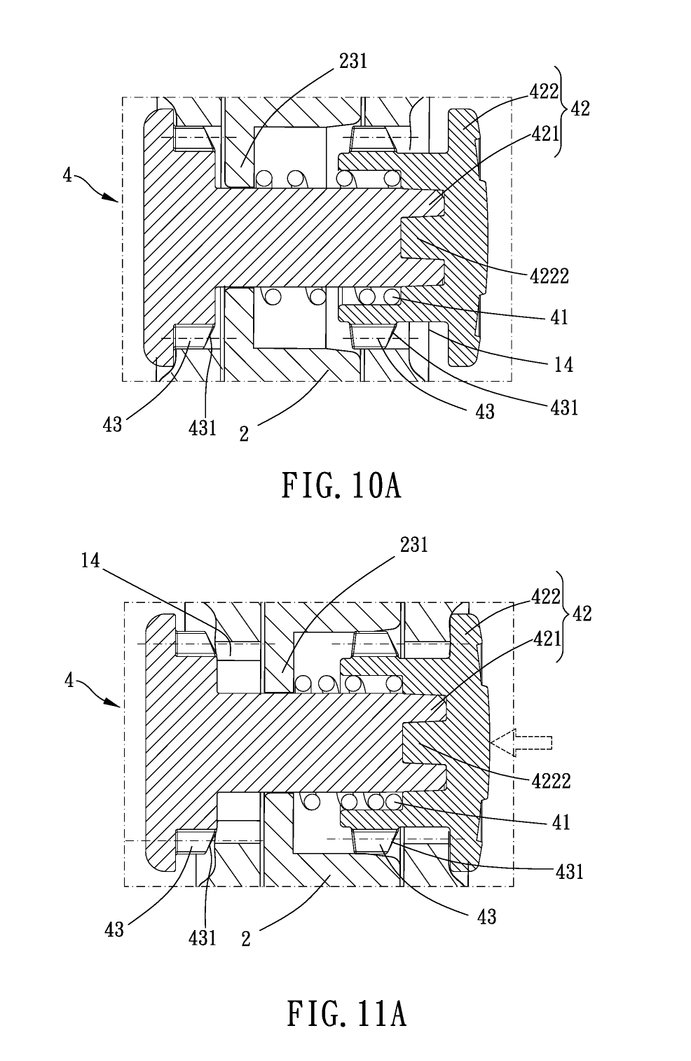

Please refer to FIG. 10 and FIG. 11, the pivot portion 4 includes an elastic element 41 and a pivot button 42. The driving handle 2 has a pivot hole 23. The pivot button 42 is assembled by a first connecting element 421 and a second connecting element 422 and inserts into the pivot hole 23 and the guiding toothed groove 14. The pivot portion 4 further has at least one restriction toothed portion 43.

The pivot button 42 is inserted into the pivot hole 23 and axially slidable between a locking position and a release position. The elastic element 31 is received in the pivot hole 23 to be biased between a stopping wall 231 of the pivot hole 23 and the pivot button 42 so that the pivot button 42 tends to move toward the locking position. When the pivot button 42 is located at the locking position, as shown in FIG. 10, the restriction toothed portion 43 is engaged with the two guiding toothed grooves 14 so that the driving handle 2 is unable to slide with respect to the two guiding toothed grooves 14. When the pivot button 42 is pressed to move to the release position, as shown in FIG. 11, the restriction toothed portion 43 is separated from the two guiding toothed grooves 14 so that the driving handle 2 is slidable with respect to the two guiding toothed grooves 14.

Preferably, the pivot button 42 has two said restriction toothed portions 43 corresponding to the two guiding toothed grooves 14 respectively. The pivot button 42 tends to retain at the locking position, and each of the restriction toothed portions 43 is engaged with one of the guiding toothed grooves 14. Each restriction toothed portion 43 has an inclined face section 431 along the axial direction of the pivot portion 4. When the pivot button 42 is pressed to move to the release position, the inclined face sections 431 of the restriction toothed portions 43 are separated from the guiding toothed grooves 14. More specifically, when the pivot button 42 is located at the release position and the width of the opening is changed, if the pivot button 42 is to be moved toward the locking position, the restriction toothed portion of a conventional pipe pliers and the guiding toothed groove contact each other because the restriction toothed portion is perpendicular to the axial direction of the pivot portion. Even though the restriction toothed portion has a chamfered edge at the opening end thereof, it is still difficult to make the restriction toothed portion and the guiding toothed groove be engaged precisely. In the present invention, the inclined face section 431 faces the guiding toothed groove 14, as shown in FIG. 11 and FIG. 11A, so the inclined face section 431 can slide into the guiding toothed groove in a point contact manner so that the restriction toothed portion 43 can be engaged with the guiding toothed groove 14 smoothly. Thus, the pivot button 42 is able to move to the locking position smoothly, as shown in FIG. 10 and FIG. 10A. As a result, the inclined face sections 431 of the two restriction toothed portions 43 make the pivot button 42 easier to move from the release position to the locking position and easy to use.

Practically, a neck portion 33 is located between the second clamping portion 31 and the sliding piece 32. Each of the side plates 131 has a flange 16 parallel to the two sliding grooves 15 wherein the flanges 16 face each other. The neck portion 33 is located between the two side plates 131 and is slidably arranged on the two flanges 16. The second clamping portion 31 is formed with an abutting face 35 at an end near the neck portion 33. The abutting face 35 abuts against the sliding face 132 on the top of the two side plates 131 to slide thereon. Thus, the clamping element 3 can slide steadily with respect to the first clamping body 1 to prevent the shaking between the clamping element 3 and the first clamping body 1. The sliding piece 32 is slidably arranged between the sliding grooves 15 so that the two sliding grooves 15 and the sliding piece 32 are prevented from collision by other objects to result the deformation of the sliding piece 32 and the sliding grooves 15. Besides, the two sliding grooves 15 are located inside the two side plates 131 so that dust may not accumulates in the sliding grooves and that the sliding grooves may not be splashed by fluid to result corrosion. Thus, the pipe pliers is more durable and has an improved accuracy.

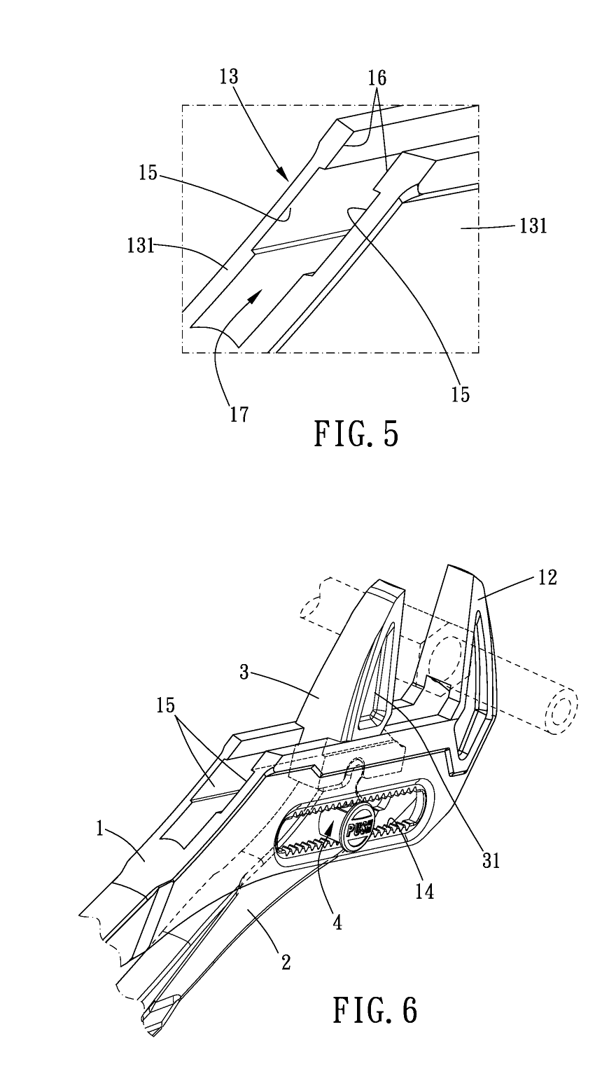

Please refer to FIG. 4, when observed along the axial direction, the maximum width of the second clamping portion 31 is defined as a first width A, and the maximum width of the sliding piece 32 is defined as a second width B. The first width A is 0.32-0.75 times the second width B. In the present embodiment, the first width A is 0.65 times the second width B. The second width B is larger than the first width A to make the sliding piece 32 stronger to support the second clamping portion 31. Thus, the deformation of the clamping element 3 and the bending of the second clamping portion 31 are prevented. Preferably, the recess 34 is formed on the sliding piece 32, and the recess 34 has a concave face. The protrusion 22 is rotatable along the axial direction in the recess 34. In other possible embodiments, the second width can be smaller than the first width, and the recess is formed at an end of the second clamping portion facing the sliding piece. The protrusion of the driving handle is rotatably inserted into the recess to make the clamping element slide with respect to the first clamping body.

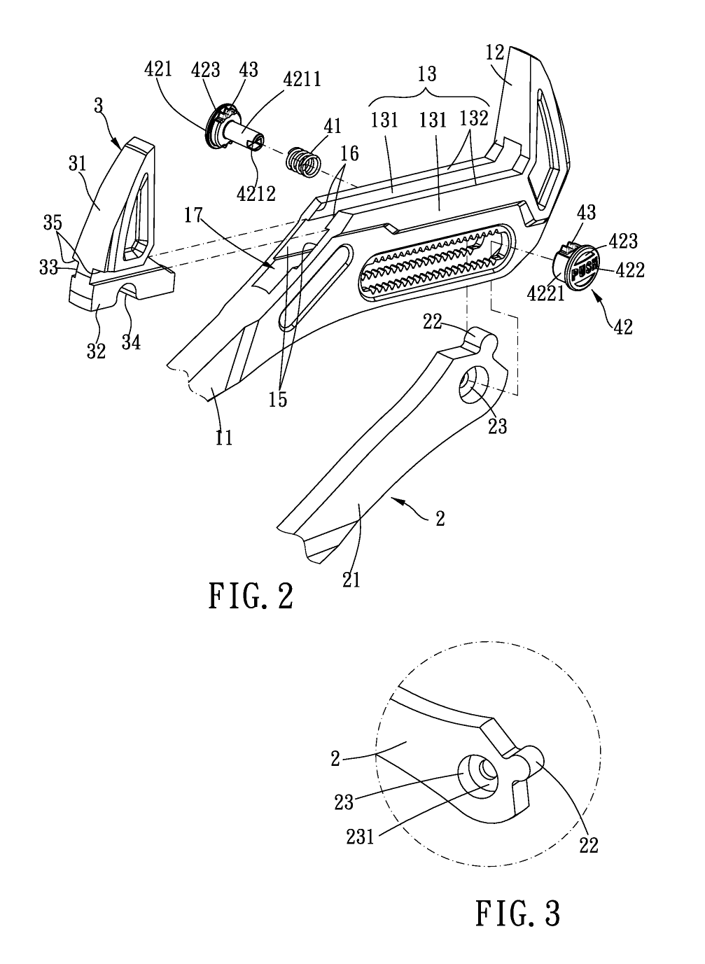

More specifically, the pivot button 42 includes a first connecting element 421 and a second connecting element 422. The first connecting element 421 has a rod portion 4211, and the second connecting element 422 has a sleeve portion 4221. The sleeve portion 4221 is sleeved onto the rod portion 4211. Each of the first connecting element 421 and the second connecting element 422 has a said restriction toothed portion 43. The two restriction toothed portions 43 correspond to the two guiding toothed grooves 14 respectively. In the present embodiment, the rod portion 4211 is formed with a notch 4212 at an end facing the sleeve portion 4221, as shown in FIG. 2. The sleeve portion 4221 is formed with a protruding portion 4222 at the bottom thereof wherein the protruding portion 4222 abuts against the notch 4222, as shown in FIG. 2, FIG. 10, and FIG. 11. The notch 4212 and the protruding portion 4222 are engaged with each other inclinedly so that the two restriction toothed portions 43 may be precisely engaged and that the rod portion 4211 is unable to rotate with respect to the sleeve portion 4221. The sleeve portion 4221 is sleeved onto the rod portion 4211 in a tight-fit manner. The rod portion 4211 can have a non-circular cross-section, and the notch is also non-circular so that the restriction toothed portions 43 may be precisely engaged with the guiding toothed grooves 14.

Besides, each of the first connecting element 421 and the second connecting element 422 preferably has a head portion 423 at an end remote from the other one of the first connecting element 421 and the second connecting element 422 wherein each of the head portion 423 has a larger diameter. The head portions of the first connecting element 421 and the second connecting element 422 are restricted at the inner wall of the guiding toothed grooves 14 so that the first connecting element 421 and the second connecting element 422 are unable to be separated from the two side plates 131.

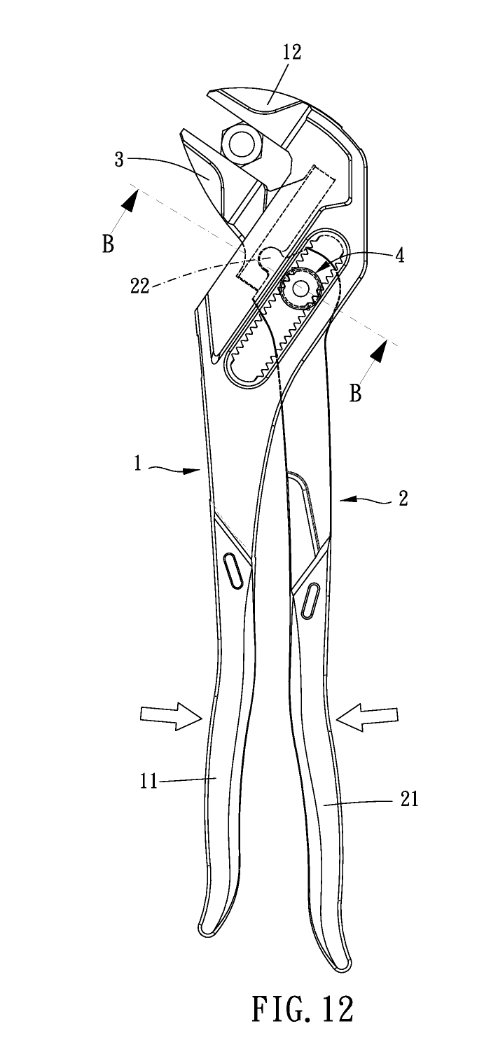

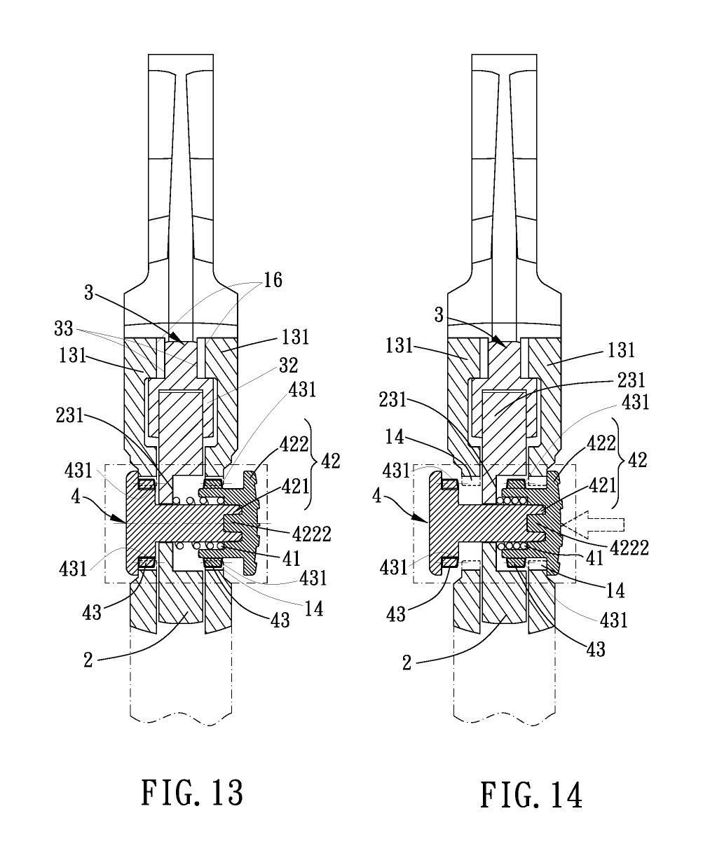

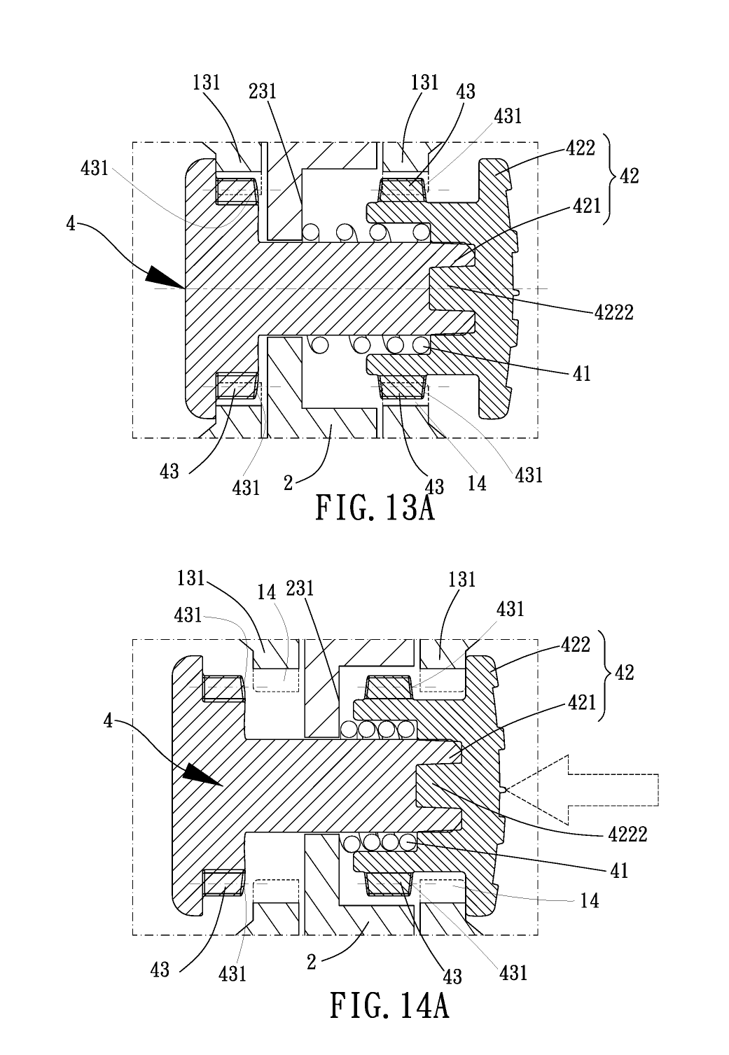

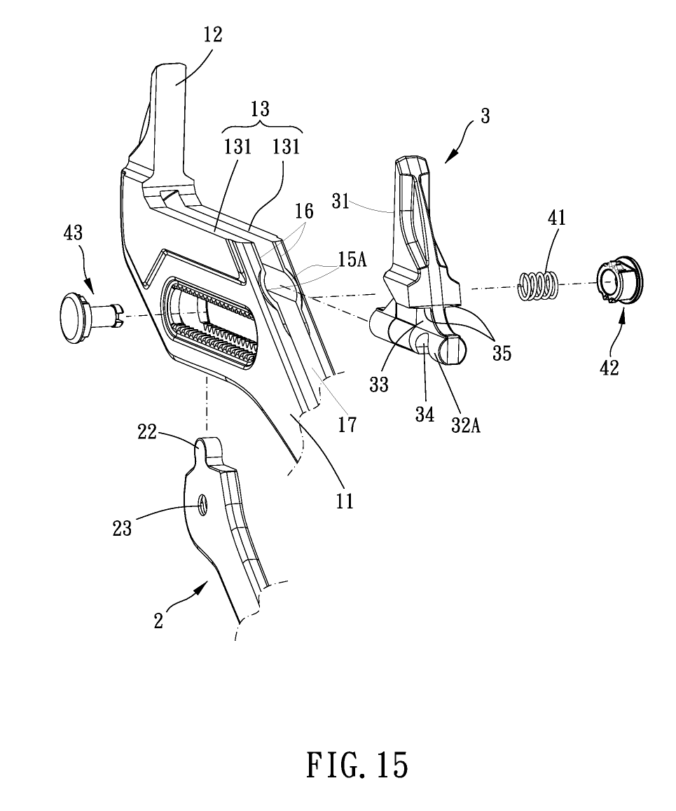

In the present embodiment, the sliding piece 3 has a rectangle cross-section. However, as shown in FIG. 12 to FIG. 15, in another embodiment of the present invention, the sliding piece 32A has a circular cross-section (FIG. 15), and the sliding grooves 15A have circular cross-sections.

In conclusion, the first clamping portion and the second clamping portion slide parallel to clamp the connector of pipe. In addition, the second clamping portion may reduce the shaking to improve the accuracy.

Besides, the sliding piece is arranged between the two sliding grooves to prevent the sliding grooves and the sliding piece from collision by other objects resulting the deformation of the two sliding grooves. In addition, the two sliding grooves are arranged inside the side plates so that dust or fluid may not enter the sliding grooves. Thus, the pipe pliers is more durable.

What is claimed is:

1. A pipe pliers, including:
a first clamping body, including a first handle portion, a first clamping portion, and a body portion connected first handle portion and the first clamping portion therebetween, the body portion including two side plates and being formed with two guiding toothed grooves, a receiving groove being defined between the two side plates, each of the side plates being formed with a sliding groove on a face thereof facing the other side plate, the two sliding grooves being parallel to but not overlap the two guiding toothed grooves;
a driving handle, restrictively and slidably arranged at the two guiding toothed grooves and pivotally connected to the first clamping body by a pivot portion, the driving handle having a second handle portion at an end and a protrusion at the other end;
a clamping element, including a second clamping portion and a sliding piece connected to each other, the sliding piece being received in the receiving groove and slidably arranged in the two sliding grooves, the second clamping portion corresponding to the first clamping portion, the clamping element being formed with a recess, the protrusion being rotatably inserted in the recess, the protrusion being able to drive the clamping element to slide with respect to the first clamping body by the driving handle sliding or pivoting with respect to the first clamping body;
wherein the pivot portion includes an elastic element and pivot button, the driving handle is formed with a pivot hole, the pivot button has at least one restriction toothed portion, the pivot button is inserted into the pivot hole and is axially slidable between a locking position and a release position, the elastic element is biased between a stopping wall of the pivot hole and the pivot button so that the pivot button tends to move toward the locking position to be locked;
wherein when the pivot button is located at the locking position, the restriction toothed portion and the two guiding toothed grooves are engaged to each other so that the driving handle is unable to slide with respect to the two guiding toothed grooves; when the pivot button is located at the release position, the restriction toothed portion is separated from the two guiding toothed grooves so that the driving handle is slidable with respect to the two guiding toothed grooves.

2. The pipe pliers of claim 1, wherein the pivot button has two said restriction toothed portions, the two restriction toothed portions correspond to the two guiding toothed grooves respectively, each restriction toothed portion is engaged with one of the guiding toothed grooves when the pivot button is located at the locking position, each of the restriction toothed portions has an inclined face section at a side along an axial direction of the pivot portion, the inclined face section of each of the restriction toothed portions faces its corresponding guiding toothed groove.

3. The pipe pliers of claim 1, wherein a neck portion is formed between the second clamping portion and the sliding piece, each of the side plates is formed with a flange parallel to the sliding grooves, the neck portion is located between the side plates, the two flanges are slidably received in the neck portion.

4. The pipe pliers of claim 3, wherein a cross-section of the sliding piece is a rectangle.

5. The pipe pliers of claim 3, wherein a cross-section of the sliding piece is circular.

6. The pipe pliers of claim 3, wherein the second clamping portion is formed with an abutting face near the neck portion, the abutting face abuts against sliding faces on tops of the two side plates.

7. The pipe pliers of claim 3, wherein when observed along the axial direction, a maximum width of the second clamping portion is defined as a first width, a maximum width of the sliding piece is defined as a second width, the first width is 0.32-0.75 times the second width.

8. The pipe pliers of claim 2, wherein a neck portion is formed between the second clamping portion and the sliding piece, each of the side plates is formed with a flange parallel to the sliding grooves, the neck portion is located between the side plates, the two flanges are slidably received in the neck portion; the second clamping portion is formed with an abutting face near the neck portion, the abutting face abuts against sliding faces on tops of the two side plates; when observed along the axial direction, a maximum width of the second clamping portion is defined as a first width, a maximum width of the sliding piece is defined as a second width, the first width is 0.65 times the second width; the recess is formed on the sliding piece, the recess has a concave face, the protrusion is rotatable in the recess around the pivot portion.

9. The pipe pliers of claim 1, wherein the recess is formed on the sliding piece, the recess has a concave face, the protrusion is rotatable in the recess around the pivot portion.

10. The pipe pliers of claim 1, wherein the pivot button includes a first connecting element and a second connecting element, the first connecting element has a rod portion, the second connecting element has a sleeve portion, the sleeve portion is sleeved onto the rod portion, each of the first connecting element and second connecting element is formed with one of the restriction toothed portions.

11. The pipe pliers of claim 10, wherein a notch is formed on an end of the rod portion facing the sleeve portion, a protruding portion is formed on a bottom of the sleeve portion wherein the protruding portion is engaged with the notch, the sleeve portion is sleeved onto the rod portion in a tight-fit manner.

12. The pipe pliers of claim 10, wherein each of the first connecting element and the second connecting element is formed with a head portion at an end remote from the other one of the first connecting element and the second connecting element, each of the head portions radially extends and has a expanded diameter, the head portions are restricted at inner walls of the two guiding toothed grooves.
